(19) United States
(12) Patent Application Publication
(10) Pub. No.: US 2006/0162571 A1
(43) Pub. Date: Jul. 27, 2006

(54) Utensil support

(76) Inventors: W. Perry Dowst, Weare, NH (US); Philip Taber, Hanover, NH (US)

Correspondence Address: WALL MARJAMA & BILINSKI, 101 SOUTH SALINA STREET, SUITE 400, SYRACUSE, NY, 13202, US

(21) Appl. No.: 11/339,930

(22) Filed: Jan. 26, 2006

Related U.S. Application Data
(60) Provisional application No. 60/648,199, filed on Jan. 27, 2005.

(51) Int. Cl. A47J 31/44

(52) U.S. Cl. 99/279

(57) ABSTRACT

The invention relates to a portable heating system. The system includes a support including an annular structure and at least one support arm attached thereto, where the support is adapted to interface with a base. The support can be used to support cooking utensils such as frying pans, skillets, and pots.

### FIELD OF THE INVENTION

The invention relates generally to systems and methods of heat exchange including systems and methods for heating food and beverages.

### BACKGROUND OF THE INVENTION

It has long been desirable to have a portable heating assembly for heating liquids and food stuffs to allow a user to prepare a heated beverage or meal at a location remote from cooking facilities. Because the user must carry the fuel used for heating, high efficiency heating is desirable to reduce the weight of fuel which must be carried. In addition, it is desirable to provide a heating assembly that is compact to facilitate transportation and storage of the device.

### SUMMARY OF THE INVENTION

The invention relates to systems and methods for using conventional cooking utensils, such as frying pans, skillets, or other cooking pots with a compact, portable, and highly efficient heating system. In one aspect, the invention includes a support comprising an annular structure and at least one support arm attached thereto, where the support is adapted to interface with a base. In one embodiment, the support has two, three, four, five, six, seven, or eight support arms. In another embodiment, the annular structure defines a center round aperture. The support arm may also pivot about a point located on the annular structure. For instance, the support arm may pivot into a recess defined by the annular structure. In another embodiment, the support arm interfaces with the base, and may optionally include a slot for interfacing with the base. In one embodiment, the slot is tapered. Optionally, the annular structure includes tabs that interface with the base.

The annular structure and the support arms can be made from various materials. For example, in one embodiment, the annular structure includes stainless steel. In another embodiment, the annular structure includes titanium. Similarly, the support arm, in one embodiment, includes stainless steel. In another embodiment, the support arm includes titanium.

These and other objects, along with the features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis generally being placed upon illustrating the principles of the invention. In the following description, various embodiments of the present invention are described with reference to the following drawings.

FIG. 1 is a schematic perspective view of a heating assembly including a utensil support coupled to a burner assembly in accordance with the present invention.

FIG. 2 is a schematic perspective view of the utensil support of FIG. 1.

FIG. 3 is a schematic perspective view of the utensil support of FIG. 1 with support arms rotated inwardly.

FIG. 4 is a schematic perspective view of a support arm in accordance with one aspect of the invention.

FIG. 5 is a schematic partial cutaway view showing the heating assembly of FIG. 1 as stowed in a vessel.

### DETAILED DESCRIPTION OF THE INVENTION

FIG. 1 shows a heating assembly 10 which includes a utensil support 100 coupled to a burner assembly 130. The utensil support 100 is configured to support conventional cooking utensils such as frying pans, skillets, or pots over the burner assembly 130.

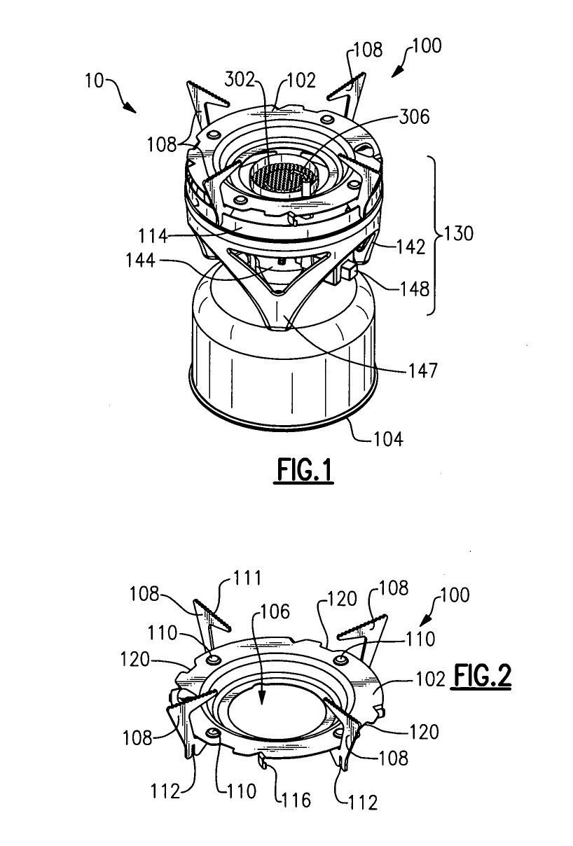

With reference to FIG. 2 the utensil support 100 includes an annular reflector 102 that includes a center round cutout 106. The utensil support 100 also includes support arms 108 that are coupled to the outer periphery of the reflector 102 using tension washers 110. Other attachment modes are able to be used such as pins or rivets. In the illustrated embodiment, the utensil support 100 includes four support arms 108. However, in other embodiments, two, three, five, six, seven, or eight support arms may be included. The support arms 108 have a ridged or serrated surface 111 that contacts the utensil when in use, but other embodiments may be without the ridges. The reflector 102 and the support arms 108 may be made from, for instance, stainless steel, titanium, or any other suitable material. The reflector 102 and the support arms 108 may be formed in a stamping operation.

With reference to FIGS. 1-2, the support arms 108 are rotatable into a first position to engage the burner assembly 130, and each support arm 108 includes a vertical tapered slot 112 that is engageable with a base 114 disposed on the burner assembly 130. The slots 112 engage the base 114, which in one from, may be a thin metal rim. Gravity and the downward force of a utensil resting on the support arms 108 of the utensil support 100 (not shown) secure the utensil support 100 to the base 114 of the burner assembly 130. Additional vertical tabs 116 formed on the reflector 102 are also engageable with the base 114 of the burner assembly 130, and provide extra support and tip resistance to the heating assembly 10.

With reference to FIG. 3, it will be seen that the support arms 108 are rotatable into a second position such that the arm body 118 fits into a recess 120 on the outer periphery of the reflector 102 as shown for the purpose of storage in a manner to be described hereinafter.

In use, the reflector 102 shields the burner assembly 130 from radiative heating resulting from heating a utensil on the utensil support 100. In certain instances, the reflector 102 may reach temperatures of up to 700 degrees Fahrenheit, while the burner assembly 130 below remains at temperatures of 150 degrees Fahrenheit or below, protecting vulnerable components within the burner assembly 130.

With reference to FIG. 1, the burner assembly 130 includes a heat source that takes the form of a burner or burner head 302. The burner receives fuel from a fuel source 104 that couples to a fuel intake port 144 of the burner assembly 130. In this embodiment, the fuel source 104 is a gas source, such as a pressurized canister of mixed propane and butane. Such fuel sources are known in the art, particularly in the camping and hiking fields. In other embodiments, the fuel source could be of a different type, such as white gas, kerosene, alcohol or gasoline. In yet other embodiments, fuel sources could include electricity or solid fuels. Ambient air is received via a gas flow path (described below) formed in the burner assembly 130. An igniter 306 provides a spark to burner 302, which causes combustion at the burner 302. The igniter 306 generates sparks in response to user activation of the igniter button 148.

The burner requires a certain amount of oxygen to produce and maintain a flame. The flame produces heated exhaust as it burns. Accordingly, the burner assembly 130 includes a gas flow path configured to enable the supply of oxygen to the burner 302 and the flow of exhaust from the burner 302. In operation, a vacuum is formed through the gas flow path that achieves this result.

Portions of the utensil support 100 and the burner assembly 130 combine to form the gas flow path. The burner assembly 130 includes a bottom housing 147 that includes a plurality of air inlet vents 142 that allow air to flow to the burner 302 from the external environment. In this embodiment, the bottom housing 147 may be made of a thermoplastic material, and also forms legs that support the burner assembly 130 when the fuel source 104 is not attached. When a cooking utensil is disposed on the utensil support 100, an exhaust path is formed between the base of the cooking utensil and a top portion of the reflector 102. The exhaust path enables the gases produced in the combustion process to travel upwards from the burner 302 through the center round cutout 106 of the reflector 102 and then radially outwards to the surrounding atmosphere.

Referring now FIG. 4, a support arm 108 is shown to include an upstanding body portion 118 terminating in the ridged surface 111, and a co-planar leg portion 119 extending downwardly and having a tapered slot 112 therein for interfacing with the base 114 as described hereinabove. An integrally connected and substantially normally extending connecting arm 121 is provided for attachment of the arm 108 to the reflector 102 by way of the tension washer 110.

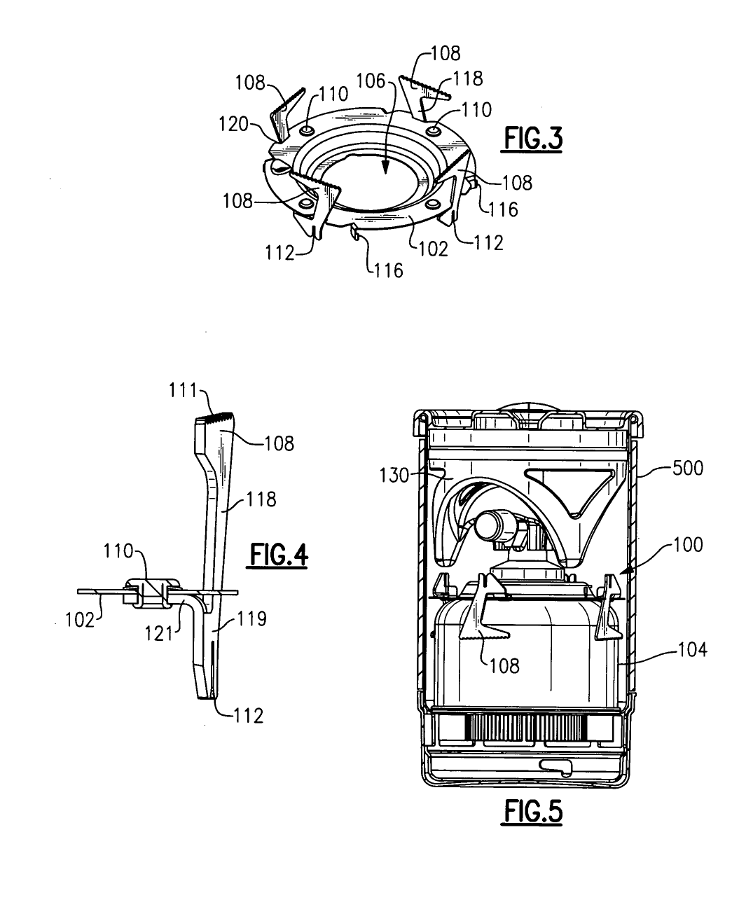

With reference to FIG. 5, the utensil support 100 is illustrated in its storage configuration. The support arms 108 are rotated inwardly to a second position and are received in the recesses 120 formed in the outer periphery of the reflector 102 as shown in FIG. 3. The utensil support 100 can then be stowed between the fuel canister 104 and the burner assembly 130 within a portable vessel 500 as illustrated in FIG. 5. The utensil support 100 can either be stowed in the inverted position as shown, with the arms 108 extending downwardly in overlapping relationship with the fuel canister 104 or it may be stowed in the same location but in a non-inverted position such that the arms 108 extend upwardly towards the burner assembly 130. In either case, this configuration allows for convenient and compact storing of the utensil support 100, along with the heating assembly 130 in the portable vessel 500.

Other embodiments incorporating the concepts disclosed herein may be used without departing from the spirit and scope of the invention. The described embodiments are to be considered in all respects as only illustrative and not restrictive.

We claim:

1. In a portable food and beverage heating assembly having a burner assembly and an annular reflector thereabove for shielding the burner assembly from radiation heat from a utensil being heated, a utensil support structure comprising:
a plurality of arms disposed at the outer periphery of and adjustably attached to the reflector and being positionable in either a first position for supportably receiving on an upper surface thereof a utensil to be heated, or in a second position for storage.

2. A utensil support structure as set forth in claim 1 wherein each of said plurality of arms is rotatably attached to said reflector so as to be pivotable about a vertical axis.

3. A utensil support structure as set forth in claim 2 wherein each of said plurality of arms has a connecting arm that is rotatably secured to a lower surface of the reflector.

4. A utensil support structure as set forth in claim 2 wherein said plurality of arms are attached to said reflector by way of tension washers.

5. A utensil support structure as set forth in claim 3 wherein each of said plurality of arms includes a downwardly extending leg portion which supportably rests on an upper surface of the burner assembly.

6. A utensil support assembly as set forth in claim 5 wherein said leg portion includes a slot which is engagable with a mating rim on a base of said burner assembly.

7. A utensil support assembly as set forth in claim 6 wherein said slot is tapered in form.

8. A utensil support structure as set forth in claim 5 wherein each of said plurality of arms includes an upwardly extending body terminating in a generally planar support surface on which the utensil can supportably rest.

9. A utensil support structure as set forth in claim 8 wherein said generally planar support surface is a serrated edge.

10. A utensil support structure as set forth in claim 8 wherein said downwardly extending portion and said upwardly extending body are co-planar.

11. A utensil support structure as set forth in claim 10 wherein said downwardly extending portion and said upwardly extending body are integrally formed as a unitary member.

12. A utensil support structure as set forth in claim 1 wherein said reflector includes for each arm, a recess formed in the outer periphery thereof for receiving a body portion of said arm when moved to said second position.

13. A utensil support structure as set forth in claim 12 wherein said reflector and attached arms when placed in said second position are storable, along with a fuel source and said heating assembly, within a portable vessel.

14. A utensil support structure as set forth in claim 1 wherein said reflector includes at its outer periphery a plurality of downwardly extending tabs to supportably engage a surface of said heating assembly.

15. A portable heating system of the type having a burner assembly and a utensil support assembly mounted thereabove for supportably receiving a cooking utensil thereon, wherein the utensil support assembly comprises:
an annular reflector having a central opening for the heat from the burner assembly to rise upwardly therethrough;
a plurality of support arms attached to and projecting upwardly from the outer periphery of said annular reflector and each arm having a support surface for supportively receiving a cooking utensil thereon wherein said plurality of support arms are rotatably mounted on their respective vertical axes such that the arms may be pivoted about such axes.

16. A portable heating system as set forth in claim 15 wherein said annular reflector includes a substantially planar portion extending in the radial direction sufficiently to provide shielding of the burner assembly from the radiative heating from the utensil being heated.

17. A portable heating system as set forth in claim 15 wherein said annular reflector includes a plurality of tabs extending downwardly to engage an upper surface of the burner assembly for supporting said annular reflector.

18. A portable heating system as set forth in claim 15 wherein said arms are pivotable between two positions, one being an operable position for supportably receiving a cooking utensil thereon and the other being in a stored position.

19. A portable heating system as set forth in claim 18 wherein said annular reflector has a plurality of notches formed on its outer periphery, and further wherein, when the plurality of support arms are moved to their stored position, they fit into the notches.

20. A portable heating system as set forth in claim 15 wherein at least one of said plurality of support arms has a downwardly extending portion with a lower surface which is adapted to engage an upper surface of the burner assembly for providing vertical support for said utensil support assembly.

21. A portable heating system as set forth in claim 20 wherein said downwardly extending portion has a vertically extending slot formed therein for engagingly receiving an upwardly extending member of said burner assembly.

22. A utensil support assembly as set forth in claim 21 wherein said slot is tapered in form.

23. A portable heating system as set forth in claim 15 wherein said plurality of support arms support surfaces are generally planar.

24. A portable hating system as set forth in claim 23 wherein said generally planar surfaces are ridged.

25. A utensil support structure as set forth in claim 15 wherein each of said plurality of arms has a connecting arm that is rotatably secured to a lower surface of the reflector.

26. A utensil support structure as set forth in claim 25 wherein said connecting arms are attached to said reflector by way of tension washers.

27. A portable heating system as set forth in claim 20 wherein each of said plurality of arms includes an upwardly extending body terminating in a generally planar portion on which the utensil can supportably rest.

28. A portable heating system as set forth in claim 27 wherein said downwardly extending portion and said upwardly extending body are integrally formed as a unitary member.

29. A portable heating system as set forth in claim 28 wherein said downwardly extending portion and said upwardly extending body are integrally formed as a unitary member.

30. A portable hating system as set forth in claim 19 wherein said reflector and attached arms when placed in said second position are storable, along with a fuel source and said heating assembly, within a portable vessel.

31. A method of fabricating a utensil support for a portable food and beverage heating assembly having a burner assembly and an annular reflector mounted thereabove, comprising the steps of:
providing a plurality of support arms with each having a support surface on one end thereof and a connecting arm intermediate the ends thereof; and
rotatably connecting said connecting arms to said annular reflector at circumferential spaced positions around the periphery thereof, with the support arms being selectively positionable between a first position for supportably receiving a cooking utensil thereon or to a second position for storage.

32. A method as set forth in claim 31 wherein said connecting arms are attached to the bottom of said reflector so as to be pivotable about a vertical axis.

33. A method as set forth in claim 1 wherein said connecting arms are connected to said reflector by way of tension washers.

34. A method as set forth in claim 31 wherein said support arms other ends extend downwardly to supportably rest on an upper surface of the burner assembly.

35. A method as set forth in claim 34 and including the step of forming a slot in said support arms other ends so as to be engageable with a mating rim on a base of said burner assembly.

36. A method as set forth in claim 35 wherein slot is tapered in form.

37. A method as set forth in claim 31 and including the step of forming a plurality of recesses in the outer periphery of the reflector, with the recesses being so placed that when the support arms are placed in said second position, they will fit in the respective recesses.

38. A method as set forth in claim 31 and including the further step of providing a plurality of downwardly extending tabs on the outer periphery of the reflector to supportably engage a surface of said heating assembly.
